(19) United States
(12) Patent Application Publication
(10) Pub. No.: US 2012/0132588 A1
(43) Pub. Date: May 31, 2012

(54) METHOD AND SYSTEM FOR TREATING OILY WASTEWATER

(76) Inventors: Xianguo Yu, Shanghai (CN); Hai Yang, Shanghai (CN); Andrew Philip Shapiro, Schenectady, NY (US); Yiwen Sun, Shanghai (CN); Wei Cai, Shanghai (CN); Chang Wei, Niskayuna, NY (US)

(21) Appl. No.: 13/071,543

(22) Filed: Mar. 25, 2011

(30) Foreign Application Priority Data
Nov. 30, 2010 (CN) 201010590907.X

(51) Int. Cl. C02F 1/44

(52) U.S. Cl. 210/639; 210/200

(57) ABSTRACT

The invention relates to a method for treating oily wastewater comprising: pretreating the oily wastewater using at least one of electrocoagulation, flotation and absorbing to produce a pretreated water; and treating the pretreated water using membrane distillation to produce a product water. In another aspect, the invention relates to a system for treating oily wastewater comprising: a pretreatment apparatus for pretreating the oily wastewater to produce a pretreated water, the pretreatment apparatus comprising at least one of an electrocoagulation apparatus, a flotation apparatus and an absorbing apparatus; and a membrane distillation apparatus for treating the pretreated water to produce a product water.

### BACKGROUND

The invention relates generally to methods and systems for treating oily wastewater. In particular, the invention relates to methods and systems for treating oily wastewater using membrane distillation.

Oily wastewater has been problematic in various industries for decades. Major industrial sources of oily wastewater include oil recovery, petroleum refining, metals manufacturing and machining, and food processing, . . . etc.

For instance, steam assisted gravity drainage (SAGD) heavy oil recovery process uses a considerable amount of steam and produces a significant amount of oily wastewater. The oily wastewater usually needs to be treated before recycling as the feed water for steam generation or before discharge, especially where the natural water supply is insufficient.

Currently, there are two known processes to treat oily wastewater in the SAGD industry, one of which is disclosed in FIG. 6 of U.S. Pat. No. 7,694,736 and FIG. 7 of U.S. Pat. No. 7,699,104, in which after separation from produced oil and gas, the oily wastewater passes through multiple different steps using different treatment technologies (such as deoiling, lime softening, filtering, and ion-exchanging, . . . etc.) before being reused for steam generation. This oily wastewater treatment process is complex.

The other process to treat the oily wastewater in the SAGD industry is to use evaporation to replace all or most of the steps of the above process for simplification. However, the evaporator needs to be made from expensive materials, such as titanium, to bear the corrosion caused by pollutants in the oily wastewater, so the evaporation has shortcomings, e.g., in the aspect of the cost.

Membrane distillation technology leverages the advantages of both the traditional thermal evaporation and membrane separation. In 1999, M. Gryta and K. Karakulski published an article titled “The application of membrane distillation for the concentration of mineral oil-water emulsions” about evaporation of water from the emulsion and the retention of oil on the feed side. However, this article also points out that the oil impedes the water vaporization in the membrane distillation and that an increasing concentration of oil in the emulsion can finally detain the vaporization of water across the membrane.

In 2001, M. Gryta, K. Karakulski and A. W. Morawski published an article titled “purification of oily wastewater by hybrid UF/MD” which disclosed using the ultrafiltration as a pretreatment for the membrane distillation. However, during operation both the ultrafiltration and the distillation use organic polymer membranes, which are typically vulnerable to fouling and need to be rinsed frequently. This is especially true for the ultrafiltration membrane.

U.S. Pat. No. 6,365,051 is directed to a method of treating an aqueous stream having inorganic material dissolved therein. The method comprises the steps of: (a) adding organic solvent to the aqueous stream in an amount effective to form an inorganic precipitate comprising at least a portion of the inorganic material; (b) removing at least most of the organic solvent from the aqueous stream by vacuum membrane distillation; and (c) after step (b), removing at least most of the inorganic precipitate from the aqueous stream. In this method, the membrane distillation is used to remove the organic solvent in the presence of inorganic precipitate, which may cause scaling of the membrane.

In 2007, Chen-Lu Yang published an article titled “Electrochemical coagulation for oily water demulsification”. Nevertheless, so far in practice, the quality of the treated water by electrochemical coagulation (or electrocoagulation) is not satisfactory.

Flotation is known as a water treatment process that clarifies wastewaters (or other waters) by the removal of suspended matters in the wastewaters (or other waters). In the flotation process, air bubbles (or any other suitable gas bubbles) adhere to the suspended matters in the water and cause the suspended matters to float to the surface of the water where it may then be removed by a skimming device.

Absorbants such as active carbon may also be added into the wastewater to absorb pollutants and purify the water.

Although electrocoagulation, flotation and absorption (or absorbing) are known processes, until now, none of them has been combined with the membrane distillation for treating oily wastewater, e.g., from SAGD oil recovery process.

Therefore, there is a need for a new method and system for treating oily wastewater, e.g., from SAGD oil recovery process.

### BRIEF DESCRIPTION

Embodiments of the invention include a method and a system for treating oily wastewater.

In one embodiment, a method for treating oily wastewater comprises pretreating the oily wastewater using at least one of electrocoagulation, flotation and absorbing to produce a pretreated water; and treating the pretreated water using membrane distillation to produce a product water.

In another embodiment, a system for treating oily wastewater comprises a pretreatment apparatus for pretreating the oily wastewater to produce a pretreated water, the pretreatment apparatus comprising at least one of electrocoagulation apparatus, flotation apparatus and absorbing apparatus; and a membrane distillation apparatus for treating the pretreated water to produce a product water.

### DRAWINGS

These and other features, aspects, and advantages of the present invention will become better understood when the following detailed description is read with reference to the accompanying drawings, wherein:

FIG. 1 shows a schematic view of a system in accordance with an embodiment of the present invention.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. Moreover, the suffix “(s)” as used herein is usually intended to include both the singular and the plural of the term that it modifies, thereby including one or more of that term.

In one embodiment, a method for treating oily wastewater comprises pretreating the oily wastewater using at least one of electrocoagulation, flotation and absorbing to produce a pretreated water; and treating the pretreated water using membrane distillation to produce a product water.

In some embodiment, the pretreating is electrocoagulation. In some embodiment, the pretreating is air or natural gas flotation. In some embodiment, the pretreating is active carbon absorbing. In some embodiment, the pretreating comprises a combination of air or natural gas flotation and electrocoagulation. In some embodiment, the pretreating comprises a combination comprising at least one of electrocoagulation, air or natural gas flotation and active carbon absorbing. In some embodiment, the product water is further treated, e.g., by active carbon absorbing.

In another embodiment, a system for treating oily wastewater comprises a pretreatment apparatus for pretreating the oily wastewater to produce a pretreated water, the pretreatment apparatus comprising at least one of electrocoagulation apparatus, flotation apparatus and absorbing apparatus; and a membrane distillation apparatus for treating the pretreated water to produce a product water.

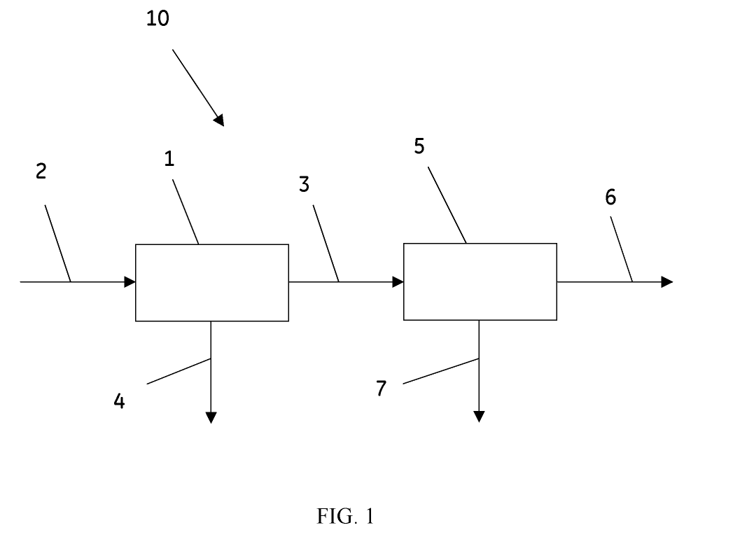

Referring to FIG. 1, a system 10 in accordance with one embodiment of the present invention comprises a pretreatment apparatus 1 for pretreating a feed stream of oily wastewater 2 to produce a stream of pretreated water 3 and a first waste stream 4, and a membrane distillation apparatus 5 for treating the pretreated water 3 to produce a stream of product water 6 and a second waste stream 7. In some embodiment, the feed stream of oily wastewater 2 is from a steam assisted gravity drainage oil recovery process. In some embodiment, the pretreated water 3 has a temperature higher than that of the product water 6. The waste stream 4, 7 may be an aqueous stream, slurry or sludge having a high concentration of impurities removed by the apparatus 1, 5.

In some embodiment, the pretreatment apparatus 1 is an electrocoagulation apparatus. In some embodiment, the pretreatment apparatus 1 is an air or natural gas flotation apparatus. In some embodiment, the pretreatment apparatus 1 is an active carbon absorbing apparatus. In some embodiment, the pretreatment apparatus 1 comprises a combination of an air or natural gas flotation apparatus and an electrocoagulation apparatus. In some embodiment, the pretreatment apparatus 1 comprises a combination comprising at least one of an electrocoagulation apparatus, an air or natural gas flotation apparatus and an active carbon absorbing apparatus.

The term “electrocoagulation” used herein refers to a method or an apparatus in which an electrical potential is applied between a cathode and an anode positioned so as to create an electric field in the oily wastewater stream, the oily wastewater and dissolved substances therein being an electrolyte. If at least one of the cathode and anode is sacrificial and is made from materials such as iron, steel, aluminum, zinc or magnesium, ions therefrom migrate into the electrolyte and bond with impurities to create precipitates. The precipitates are then physically removed from the oily wastewater stream as the waste stream by means of floatation, sedimentation and filtering, for example. Moreover, the disassociation of water molecules forms oxygen, hydrogen and hydroxyls, which can also be involved in beneficial reactions, e.g. oxidation-reduction reactions, and can also interact with biologics, if present, with treatment effect. Moreover, microbubbles formed can physically interact with suspended materials and form precipitates to aid in removal by floatation or aggregation.

When operating the electrocoagulation apparatus with non-sacrificial electrodes, for example with electrically conductive synthetic graphite electrodes or titanium electrodes, the necessary positively charged ions for maintaining the electrocoagulation process are partially provided by the feed water itself. The remaining part of the required positively charged ions are added in the form of metallic ions such as salts of aluminum, calcium, ferrum or magnesium. For an enhanced electron migration, the electrocoagulation process may be operated within the acidic range through chemical dosing with hydrochloric (HCl), sulfuric (H₂SO₄) or phosphoric acid (H₃PO₄).

Depending on the ingredients of the oily wastewater to be treated, additives may be used if needed during the electrocoagulation. For example, when non-sacrificial cathodes and anodes are used, the additives may be used to form ions to interact with solutes and particulate matter in coagulating the impurities out of suspension and solution. When sacrificial cathodes and anodes are used, additives may be used to increase the conductivity of the water stream to enhance electrocoagulation processes. The additives may be later removed, or involved in the chemical processes to form precipitates. In addition, to improve flocculation, flocculants may be added during electrocoagulation too.

The term “flotation” used herein refers to a method or apparatus in which air (or any other suitable gases, such as natural gas, or any suitable mixtures of gases) bubbles released into the feed stream of the oily wastewater are attached with suspended particles. The air-solid mixture rises to the surface of the wastewater where it concentrates and is removed. In some embodiments, the flotation may be electroflotation, an electric version of flotation, in which bubbles are generated predominately by the electrolysis of water. Instead of air, hydrogen and oxygen bubbles are generated to perform the binding function in the electroflotation.

The term “absorbing or absorption” used herein refers to a method or apparatus in which absorbants, such as active carbon, are used to absorb impurities in the water.

In some embodiments, there may be other treatment apparatuses between the pretreatment apparatus and the membrane distillation apparatus.

The term “membrane distillation” used herein refers to a method or apparatus in which vapor transports through pores of a hydrophobic membrane separating two liquid solutions. The liquid solution cannot enter the membrane pores unless the applied pressure is greater than the specified “liquid entry pressure” for the porous partition of a given membrane. In the absence of such a pressure, vapor-liquid interfaces are formed on both sides of the membrane pores due to surface tension forces. Under these conditions, if a temperature difference is applied, evaporation will take place at the warm membrane interface from the feed stream, vapor will transport through the membrane pores with a convective and/or diffusion mechanism, and condensation will take place at the cold membrane interface to produce the product water.

The term “hydrophobic” used herein is to be understood in the conventional sense. That is, a surface is “hydrophobic” when the relative attraction between the water molecules is more than the attraction between the water molecules and the surface. The angle of contact between the liquid and a hydrophobic surface is greater than 90 degree (in the absence of other forces).

The following synthetic (polymeric) materials are especially suitable for the hydrophobic membrane: polytetrafluoroethylene, polyvinyl chloride and polypropylene.

In some embodiments, the membrane distillation apparatus may be a direct contact membrane distillation apparatus where both the warm, vaporizing feed stream and the cold condensate stream (product water) are in direct contact with the membrane of the membrane distillation apparatus.

In some embodiments, the membrane distillation apparatus may be an air gap membrane distillation apparatus, where the product water is separated from the membrane by an air gap.

In some embodiments, the membrane distillation apparatus may be a sweeping gas membrane distillation apparatus where the product water is removed in vapor form by an inert gas.

In some embodiments, the membrane distillation apparatus may be a vacuum membrane distillation apparatus where the product water is removed in vapor form by vacuum.

In this invention, while treating the oily wastewater, the pretreatment apparatus helps to reduce the frequency with which the membrane distillation apparatus needs to be washed, and in combination with the membrane distillation apparatus improves the quality of the product water.

The membrane distillation apparatus may be washed in different ways using different washing agents known to one of ordinary skill in the art. For example, a sodium hydroxide (NaOH) aqueous solution and deionized water may be used sequentially to wash the membrane when needed.

### EXAMPLES

The following examples are included to provide additional guidance to those of ordinary skill in the art in practicing the claimed invention. Accordingly, these examples do not limit the invention as defined in the appended claims.

### Comparative Example

A flat-sheet hydrophobic microporous polypropylene membrane (water contact angle: 136°, average pore size: 0.1 μm, membrane thickness: 100 μm, porosity: 6570%, from GE Osmonics Inc., Minnetonka, Minn., USA) was used as the separator in a membrane distillation (MD) apparatus here. The membrane was assembled inside a module having two symmetrical plastic plates made from polyoxymethylene, which provided a flow channel on each of two opposite sides of the membrane. The effective membrane area was 16 cm². The MD module was then integrated into a testing platform including a heater (Julabo 5, Power: 2 kw, JULABO Labortechnik GmbH, Seelbach, Germany), a chiller (Julabo F12, Cooling Power: 160 w, JULABO Labortechnik GmbH, Seelbach, Germany), pumps (DP130, 0˜1.7 L/min, Xin Xi Shan Industrial Co. Ltd., Shanghai, China) and temperature/pressure sensors as well as cycling pipes and controlling valves.

About 1200 ml of raw water (obtained from a steam assisted gravity drainage oil recovery factory located at Connacher of Canada) was placed in a glass beaker (the feed water container). The beaker was then sealed and the raw water was heated to about 60° C. before it was fed into one of the flow channels in the MD module through the cycling pipes. The feed water cycled between the beaker and the flow channel while maintaining the temperature at about 60° C. The linear flow rate of the feed water was 30 cm/s.

Pure water (400 ml) of 20° C. flowed from another glass beaker (the product water container) with a linear flow rate of 25 cm/s as a start up and cycled with the product water produced during operation between the other of the flow channels and the product water container.

In order to characterize the water qualities and to evaluate the treating effects, a conductivity monitor (SevenMulti, Sensor: 0˜500 mS/cm, Mettler Toledo Instruments (China) Co. Ltd., Shanghai, China), a chemical oxygen demand (COD) analyzer (HACH 5000, DR/5000, HACH Company, Loveland, Colo., USA) and a total organic carbon (TOC) analyzer (5310 C Laboratory TOC Analyzer, GE Analytical Instruments, Boulder, Colo., USA) were used to measure the specific conductivity, the COD and the TOC of the raw water as received at the room temperature which, unless specified otherwise, were maintained at the same level until being treated in the experiments.

The weight of the product water was measured using a balance (PL4100, Mettler Toledo Instruments (China) Co. Ltd., Shanghai, China) to monitor the flux of the membrane in the membrane distillation module during operation. The flux herein means the amount of product water (kg) in unit membrane area (m²) and in unit time (hour). It is calculated using the formula: weight of product water/(membrane area×running time). When the flux of the membrane dropped to less than 5 kg/m² hour, this experiment was stopped and the COD, the TOC and the specific conductivity of the product water were also measured. The parameters are respectively listed in table 1 below. Inductively coupled plasma (ICP) testing on elements (ions) in the raw water and the product water were also conducted at the same time as the other tests and the results are shown in table 2 below.

TABLE 1

| | COD | TOC | Specific Conductivity |
|---|---|---|---|
| | mg/L | mg/L | μS/cm |
| Raw water | 820 | 233 | 1872 |
| Product water | 68 | 8.3 | 103 |
| Rejection (%) | 91.7 | 96.4 | 94.5 |

TABLE 2

| | Raw water | Product water |
|---|---|---|
| Element | mg/L | mg/L |
| Na⁺ | 304.2 | 3.39 |
| Cl⁻ | 340.3 | <50.0 |
| Ca⁺⁺ | 3.06 | 0.12 |
| SO₄⁻⁻ | 73.3 | 8.76 |
| Silica | 27.7 | <0.10 |
| B⁺⁺⁺ | 8.73 | 0.19 |
| K⁺ | 17 | 0.2 |
| Li⁺ | 0.89 | <0.10 |
| Cu⁺⁺ | <0.10 | 0.2 |
| Sr⁺⁺ | 0.17 | <0.10 |
| Al⁺⁺⁺ | <0.10 | <0.10 |
| Ba⁺⁺ | <0.10 | <0.10 |
| Cd⁺⁺ | <0.10 | <0.10 |
| Co⁺⁺⁺ | <0.10 | <0.10 |
| Cr⁺⁺⁺ | <0.10 | <0.10 |
| Fe⁺⁺⁺ | <0.10 | <0.10 |
| Mg⁺⁺ | <0.10 | <0.10 |
| Mn⁺⁺ | <0.10 | <0.10 |
| Mo⁺⁺⁺ | <0.10 | <0.10 |
| Ni⁺⁺ | <0.10 | <0.10 |

The “rejection” in table 1 was calculated by using the following formula: (value of raw water-value of product water)/value of raw water×100%. From the results shown in table 1, the rejections of the COD, the TOC and the specific conductivity are above 90%. However, the values of the COD, the TOC and the specific conductivity of the product water still have space to improve for some application environments, e.g., when the product water is used as the feed water for a boiler.

### Example 1

Raw water (500 ml, the same as that used in the comparative example) was placed in a glass beaker. Two symmetric steel plate electrodes (3.2 cm×4 cm) were immerged partly in the water. There was a direct current supply (Land 2000, DC voltage range: 0-25V, Maximum current: 5A, Wuhan Kinguo Electronics Co., Ltd., Wuhan, China) connected with the two electrodes.

The raw water was heated to and maintained at 85° C. A constant current (500 mA) was charged into the electrodes for 10 minutes for conducting electrocoagulation (EC). A sand filter was used to filter materials coagulated and suspended in the water to obtain filtrate water. Three bottles of filtrate water (EC treated water) samples (10 ml each) were taken for the COD, the TOC and the conductivity measurements, respectively, when the filtrate water was cooled naturally to the room temperature.

Other filtrate water (EC treated water) was used as the feed water at the temperature of 60° C. for the membrane distillation apparatus (MD) similar with the membrane distillation apparatus of the comparative example under the same operation condition as that of the MD process in the comparative example. When the flux of the membrane dropped to about 5 kg/m² hour, the MD process was stopped and the COD, the TOC and the specific conductivity of the product water from the MD process were tested. CODs, TOCs and specific conductivities of the raw water, the EC treated water and the product water from MD are shown in table 3 below.

TABLE 3

| | COD | TOC | Specific Conductivity |
|---|---|---|---|
| | mg/L | mg/L | μS/cm |
| Raw water | 820 | 233 | 1872 |
| EC treated water | 495 | 118 | 1824 |
| MD product water | 63 | 7.9 | 18 |
| Overall Rejection (%) | 92.3 | 96.6 | 99.0 |

The “overall rejection” in table 3 and following tables was calculated by using the following formula: (value of raw water-value of water from last step)/value of raw water×100%.

It can be seen from table 3 that the parameters of the product water are not what will be expected from a combination of the EC process and the MD process. For example, the COD of the EC treated water is 60.4% of that of the raw water, while the COD of the MD product water is 92.6% of and higher than 60.4% of that of the product water of the comparative example. The TOC of the EC treated water is about 50.6% of the raw water but the TOC of the MD product water is 95.2% of and higher than 50.6% of that of the product water of the comparative example. On the other hand, though the specific conductivity of the EC treated water is about 97.4% of that of the raw water, the specific conductivity of the product water from MD is only 17.5% of and much lower than 97.4% of that of the product water from the MD of the comparative example where the feed water for MD is not pretreated. In addition, the values of the COD, the TOC and especially, the specific conductivity of the product water from the MD process decreased compared with those of the product water from the MD process in the comparative example.

### Example 2

Raw water (4000 ml, the same as the raw water used in the comparative example) was put in a 5000 ml glass beaker. A zeolite (pore size: 0.1 mm) connected with a compressed air pipe was put into the beaker. The compressed air (pressure: 0.8 psi) blew through the zeolite to generate bubbles in the raw water in the beaker. This operation continued overnight in a ventilation hood. The material adhering to the wall of the glass beaker and suspended in the water were skimmed to obtain the air flotation (AF) treated water. About 10% weight loss was found by comparing the weights of water before and after the air floatation process. Then about 1200 ml of the AF treated water was taken to work as the feed water for the MD module. The MD and the operation condition thereof were the same as those in example 1.

CODs, TOCs and specific conductivities of the raw water, the AF treated water and the product water from the MD are shown in table 4 below.

TABLE 4

| | COD | TOC | Specific Conductivity |
|---|---|---|---|
| | mg/L | mg/L | μS/cm |
| Raw water | 820 | 233 | 1872 |
| AF treated water | 410 | 81.6 | 1847 |
| MD product water | 14 | 2.8 | 9.6 |
| Overall Rejection (%) | 98.3 | 98.8 | 99.5 |

It can be seen from table 4 that though the COD of the AF treated water is half of that of the raw water, the COD of the MD product water is 20.6% of and much less than half of that of the product water of the comparative example. The TOC of the AF treated water is about 35% of the raw water but the TOC of the MD product water is only 33.7% of that of the product water of the comparative example. The specific conductivity of the AF treated water is 98.7% of that of the raw water, the specific conductivity of the product water from the MD is only 9.3% of that of the product water from the MD of the comparative example where the feed water for MD is not pretreated.

### Example 3

Active carbon (AC, specific area: 600 m²/g; particle size: 1˜2 mm; pore size: 2-3 nm) was filled in a glass column (diameter: 2 cm, length: 1.1 m) that was fixed vertically in a clamp. At the top inlet of the glass column there was a dropping funnel in which the raw water was placed. Controlled with a constant flow rate of 20 ml/min at room temperature, the raw water flowed through the active carbon column. The effluent water from the AC column was the AC treated water, which was used further as the feed water for the MD apparatus similar with those in examples 1-2 and under the operation condition similar with those of MD processes in examples 1-2. The CODs, TOCs and the specific conductivity of different waters are shown in table 5 below.

TABLE 5

| | COD | TOC | Specific Conductivity |
|---|---|---|---|
| | ppm | ppm | μS/cm |
| Raw water | 820 | 233 | 1872 |
| AC treated water | — | 74 | 1560 |
| MD product water | — | 4.91 | 31.1 |
| Overall Rejection (%) | — | 97.9 | 98.3 |

After the AC pretreatment and the MD treatment, the COD decreased to a non-detectable quantity. The TOC of the AC treated water is about 31.8% of that of the raw water but the TOC of the MD product water is about 59.2% of that of the product water of the comparative example. The specific conductivity of the AC treated water is 83.3% of that of the raw water but the specific conductivity of the MD product water is only about 30.2% of that of the product water in the comparative example.

### Example 4

The raw water of this experiment was different from those of the comparative example and examples 1-3 and the COD, the TOC and the specific conductivity thereof are listed in table 6 below.

In the experiment, the raw water was first treated using AF under the same condition as that of example 2, then using EC and MD in the same way as in example 1. Finally, the product water from the MD apparatus was further polished in a glass column filled with active carbon and similar with that in example 3. Table 6 below presents characteristics of water during different stages.

TABLE 6

| | COD | TOC | Specific Conductivity |
|---|---|---|---|
| | mg/L | mg/L | μS/cm |
| Raw water | 769 | 178 | 1748 |
| AF treated water | 405 | 70.4 | 1679 |
| EC treated water | 281 | 33.4 | 1530 |
| MD product water | 27 | 2.58 | 5.1 |
| AC Polished water | 1 | 0.57 | 11.4 |
| Overall Rejection (%) | 99.8 | 99.7 | 99.3 |

From table 6 it can be seen that after all of the treatments, the COD and the TOC of the water decreased to 1 mg/L and 0.57 mg/L respectively and the overall rejections of the COD, the TOC and the specific conductivity are all above 99%. Table 7 shows ICP results of elements (ions) of water at different stages and shows that most unwanted ions are removed after all of the treatments. It is noted that iron ions increased after the EC process because the steel anode electrochemically oxidized and irons dissolved into water during EC.

TABLE 7

| | | AF treated | | | |
|---|---|---|---|---|---|
| | Raw Water | water | EC treated | MD product | AC treated |
| | (mg/L) | (mg/L) | water | water | water |
| Element | (mg/L) | (mg/L) | (mg/L) | (mg/L) | (mg/L) |
| Na⁺ | 302.2 | 297.6 | 273.9 | 0.41 | 0.26 |
| Cl⁻ | 337.3 | 316.8 | 228.4 | <10.0 | <10.0 |
| Ca⁺⁺ | 3.02 | 2.92 | 4.4 | 0.43 | 6.08 |
| SO₄⁻⁻ | 71.6 | 67.3 | 33.8 | 0.65 | 1.61 |
| Silica | 26.3 | 22.5 | 20.2 | 0.21 | 2.98 |
| B⁺⁺⁺ | 8.14 | 8.07 | 8.1 | <0.10 | <0.10 |
| K⁺ | 15.9 | 14.8 | 14.2 | <0.10 | <0.10 |
| Li⁺ | 0.81 | 0.78 | 0.7 | <0.10 | <0.10 |
| Ba⁺⁺ | <0.10 | <0.10 | 0.3 | <0.10 | <0.10 |
| Al⁺⁺⁺ | <0.10 | <0.10 | 0.3 | <0.10 | 0.10 |
| Mg⁺⁺ | <0.10 | <0.10 | 0.4 | <0.10 | 0.28 |
| Mn⁺⁺ | <0.10 | <0.10 | <0.10 | <0.10 | <0.10 |
| Fe⁺⁺ | <0.10 | <0.10 | 14.1 | <0.10 | <0.10 |
| Co⁺⁺⁺ | <0.10 | <0.10 | 0.0 | <0.10 | <0.10 |
| Ni⁺⁺ | <0.10 | <0.10 | 0.1 | <0.10 | <0.10 |
| Zn⁺⁺ | <0.10 | <0.10 | <0.10 | <0.10 | <0.10 |
| Mo⁺⁺⁺ | <0.10 | <0.10 | <0.10 | <0.10 | <0.10 |
| Cu⁺⁺ | <0.10 | <0.10 | <0.10 | <0.10 | <0.10 |
| Cd⁺⁺ | <0.10 | <0.10 | <0.10 | <0.10 | <0.10 |
| Sr⁺⁺ | 0.15 | 0.15 | <0.10 | <0.10 | 0.10 |
| Cr⁺⁺⁺ | <0.10 | <0.10 | <0.10 | <0.10 | <0.10 |
| Zr⁺⁺ | <0.10 | <0.10 | <0.10 | <0.10 | <0.10 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for treating oily wastewater comprising:
pretreating the oily wastewater using at least one of electrocoagulation, flotation and absorbing to produce a pretreated water; and
treating the pretreated water using membrane distillation to produce a product water.

2. The method of claim 1, wherein the oily wastewater is from steam assisted gravity drainage oil recovery process.

3. The method of claim 1, wherein the pretreating comprises electrocoagulation.

4. The method of claim 3, wherein an electrode used in the electrocoagulation comprises iron, steel, aluminum, zinc or magnesium.

5. The method of claim 1, wherein the pretreating comprises active carbon absorbing.

6. The method of claim 1, wherein the pretreating comprises air flotation or natural gas flotation.

7. The method of claim 6, wherein a zeolite introduces air or natural gas during the flotation.

8. The method of claim 1, wherein the pretreating comprises a combination of air or natural gas flotation and electrocoagulation.

9. The method of claim 8, wherein the product water is further treated by active carbon absorbing.

10. The method of claim 1, wherein the pretreated water has a temperature higher than that of the product water.

11. A system for treating oily wastewater comprising:
a pretreatment apparatus for pretreating the oily wastewater to produce a pretreated water, the pretreatment apparatus comprising at least one of an electrocoagulation apparatus, a flotation apparatus and an absorbing apparatus; and
a membrane distillation apparatus for treating the pretreated water to produce a product water.

12. The system of claim 11, wherein the oily wastewater is from steam assisted gravity drainage oil recovery process.

13. The system of claim 11, wherein the pretreatment apparatus comprises an electrocoagulation apparatus.

14. The system of claim 13, wherein the electrocoagulation apparatus comprises an electrode made from iron, steel, aluminum, zinc or magnesium.

15. The system of claim 11, wherein the pretreatment apparatus comprises an active carbon absorbing apparatus.

16. The system of claim 11, wherein the pretreatment apparatus comprises an air or natural gas flotation apparatus.

17. The system of claim 16, wherein the pretreatment apparatus comprises a zeolite for introducing air or natural gas.

18. The system of claim 11, wherein the pretreatment apparatus comprises a combination of an air or natural gas flotation apparatus and an electrocoagulation apparatus.

19. The system of claim 18, further comprising an active carbon absorbing apparatus for treating the product water.

20. The system of claim 11, wherein the pretreated water has a temperature higher than that of the product water.
